(19) United States
(12) Patent Application Publication
(10) Pub. No.: US 2018/0215616 A1
(43) Pub. Date: Aug. 2, 2018

(54) METHODS FOR REFORMATION OF GASEOUS HYDROCARBONS USING ELECTRICAL DISCHARGE

(71) Applicant: KING ABDULLAH UNIVERSITY OF SCIENCE AND TECHNOLOGY, Thuwal (SA)

(72) Inventors: Min Suk CHA, Thuwal (SA); Xuming ZHANG, Thuwal (SA)

(21) Appl. No.: 15/743,161

(22) PCT Filed: Aug. 5, 2016
(86) PCT No.: PCT/IB2016/054745

§ 371 Date: Jan. 9, 2018

Related U.S. Application Data
(60) Provisional application No. 62/202,441, filed on Aug. 7, 2015.
(60) Provisional application No. 62/202,462, filed on Aug. 7, 2015.

(51) Int. Cl. C01B 3/34; B01J 19/08

(52) U.S. Cl. CPC C01B 3/342; B01J 19/088; C01B 2203/0222; C01B 2203/0211; B01J 2219/0894; C01B 2203/1235; B01J 2219/0809; B01J 2219/0875; C01B 2203/0861

(57) ABSTRACT

Methods for the reformation of gaseous hydrocarbons are provided. The methods can include forming a bubble containing the gaseous hydrocarbon in a liquid. The bubble can be generated to pass in a gap between a pair of electrodes, whereby an electrical discharge is generated in the bubble at the gap between the electrodes. The electrodes can be a metal or metal alloy with a high melting point so they can sustain high voltages of up to about 200 kilovolts. The gaseous hydrocarbon can be combined with an additive gas such as molecular oxygen or carbon dioxide. The reformation of the gaseous hydrocarbon can produce mixtures containing one or more of H₂, CO, H₂O, CO₂, and a lower hydrocarbon such as ethane or ethylene. The reformation of the gaseous hydrocarbon can produce low amounts of CO₂ and H₂O, e.g. about 15 mol-% or less.

### CROSS-REFERENCE TO RELATED APPLICATIONS

This application claims priority to, and the benefit of, co-pending U.S. provisional application entitled “METHODS FOR REFORMATION OF GASEOUS HYDROCARBONS USING ELECTRICAL DISCHARGE” having Ser. No. 62/202,441, filed Aug. 7, 2015 and co-pending U.S. provisional application entitled “PLASMA DEVICES FOR HYDROCARBON REFORMATION” having Ser. No. 62/202,462, filed Aug. 7, 2015, the contents of which are incorporated by reference in their entirety.

### TECHNICAL FIELD

The present disclosure generally relates to reformation of hydrocarbons.

### BACKGROUND

Today, the importance of renewable and alternative energy is gaining increasing attention due to the depletion of fossil fuel and the serious environmental problems caused by the excessive consumption of fossil fuel. It is required to use low-grade fuels having low calorific values to produce clean fuels and value-added chemicals. The utilization and reformation of gaseous hydrocarbons, which could be alkanes, alkenes, alkynes or aromatic hydrocarbons, is a promising idea to meet such requirements. Electrical discharge technology has attracted considerable interests in recent years in the reforming of hydrocarbons. However, conventional electrical discharge based hydrocarbon reformers are designed operating in the gaseous phase. For such gaseous phase reformers, the technical difficulties include controlling reaction temperature in the after glow region, radical quenching, and product separation. Other reformation, such as those described in Ding et al., Applied Energy, 2013, 104:777-782 use liquid hydrocarbons and require liquid nitrogen to cool the reaction.

Accordingly, there is a need to address the aforementioned deficiencies and inadequacies in hydrocarbon reformation, especially for the reformation of gaseous hydrocarbons.

### SUMMARY

We provide a solution to reformation of gaseous hydrocarbons. In certain embodiments, this disclosure describes various methods for reformation of gaseous hydrocarbons using electrical discharge in an aqueous medium. The methods can provide for rapid cooling of reaction temperature, controlling radical quenching reactions, and/or products separation. The methods can be used for improving the efficiency of hydrogen production and value-added chemicals such as acetylene production.

The reformation of gaseous hydrocarbon in the aqueous medium can have many advantages, including but not limited to, (1) the evaporation of water can quickly take away the heat produced from plasma, which results in a very rapid cooling of reaction temperature (˜10⁸-10¹⁰ K/s), and lead to the high selectivity of heavier hydrocarbons; (2) the existence of water can help prevent H radical quench reaction H+OH→H₂O, so that H₂ selectivity can be increased; (3) water-resolvable products can be quickly separated from the plasma into an aqueous medium. Products selectivity can also be controlled by controlling the temperature of the aqueous medium.

Methods of reformation of a gaseous hydrocarbon are provided. The methods can include generating a bubble in a liquid, where the bubble contains the gaseous hydrocarbon. The bubble can be generated such that it passes through the liquid and in a gap between a pair of electrodes; whereby an electrical discharge is produced in the bubble at the gap between the pair of electrodes. The electrical discharge can cause the reformation of the gaseous hydrocarbon.

The methods can be used with a variety of liquids. For example, the liquid can have an electrical conductivity of about 0.1-1000000 μS/cm and/or a pH of about 0-14, e.g. about 5, about 6, or about 7. The methods can include controlling the temperature of the liquid using an air bath, an ice bath, or a liquid bath.

The methods can be used for the reformation of a variety of pure and/or mixtures of gaseous hydrocarbons including methane, ethane, propane, butane, ethene, propene, butene, ethyne, propyne, butyne, and mixtures thereof. Additional additive gases can be included in the bubble, for example molecular oxygen (O₂), carbon dioxide (CO₂), and mixtures thereof. The method can include cooling the liquid and/or the bubble at a rate of about 10⁸ K/s to 10¹⁰ K/s.

The bubble can be generated by different means so long as the bubble is generated in such a way that it passes through the liquid and in a gap between a pair of electrodes. The bubble can be generated using a bubble generator coupled to a gas source. One or both of the electrodes in the pair of electrodes can have openings coupled to a gas source and the bubble is generated using the electrode.

The electrode can have different configurations and be made from numerous materials. In some embodiments the electrode has a wire-like configuration, a plate-like configuration, a pin-like configuration, a rod-like configuration, a cylinder-like configuration, or a combination thereof. The pair of electrodes can thus be arranged in a wire to plate configuration, a plate to plate configuration, a pin to plate configuration, a pin to pin configuration, a pin to rod configuration, a rod to rod configuration, a wire to cylinder configuration, or a combination thereof. The electrode can be made from material having a high melting point such as iron, copper, tungsten, gold, platinum, or an alloy or combination thereof.

The electrical discharge can be produced with a pulsed power supply, an alternating current (AC) power supply, or a direct current (DC) power supply. The power supply can supply from 0 to 200 kilovolts of voltage to the electrodes.

The reformation of the gaseous hydrocarbon can produce a lower hydrocarbon H₂, CO, H₂O, CO₂, or a combination thereof. The lower hydrocarbon can be, for example, ethane, ethylene, propane, propylene, or a mixture thereof. The reformation of the gaseous hydrocarbon can produce a syngas. The reformation of the gaseous hydrocarbon can produce about 15 mol-% or less of CO₂ and H₂O. The reformation of the gaseous hydrocarbon can produce about 20 mol-% or more of the lower hydrocarbon. The reformation of the gaseous hydrocarbon can produce about 60% mol-% or more of H₂.

Other systems, methods, features, and advantages of the present disclosure for reformation of gaseous hydrocarbons will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of a method for plasma based gaseous hydrocarbon reforming in an aqueous medium.

FIGS. 2A-2F depict some examples of electrode configurations for producing electrical discharge: (FIG. 2A) wire to plate, (FIG. 2B) plate to plate, (FIG. 2C) pin to plate, (FIG. 2D) pin to pin, (FIG. 2E) pin to rod, and (FIG. 2F) rod to rod.

### DETAILED DESCRIPTION

Described below are various embodiments of methods for reformation of gaseous hydrocarbons. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### DISCUSSION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

### Definitions

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The terms “reformation” and “reforming”, as used interchangeably herein, refer to the process of converting a hydrocarbon to methane, lower hydrocarbons, hydrogen gas, water, carbon dioxide, carbon monoxide, and combinations thereof. The process can include converting at least about 20 mol. %, 30 mol. %, 40 mol. %, 50 mol. %, 60 mol. %, 70 mol. %, 80 mol. %, 85 mol. %, 90 mol. %, 95 mol. %, 98 mol. %, or more of the hydrocarbon into methane, lower hydrocarbons, hydrogen gas, water, carbon dioxide, carbon monoxide, or a combination thereof.

The term “hydrocarbon”, as used herein, refers generally to any saturated on unsaturated compound including at least carbon and hydrogen and, optionally, one or more additional atoms. Additional atoms can include oxygen, nitrogen, sulfur, or other heteroatoms. In some embodiments the hydrocarbon includes only carbon and hydrogen. The hydrocarbon can be a pure hydrocarbon, meaning the hydrocarbon is made of only carbon and hydrogen atoms. The term “hydrocarbon” includes saturated aliphatic groups (i.e., an alkane), including straight-chain alkanes, branched-chain alkanes, cycloalkanes, alkyl-substituted cycloalkanes, and cycloalkyl-substituted alkanes. In preferred embodiments, a straight chain or branched chain alkane has 30 or fewer carbon atoms in its backbone (e.g., C₁-C₃₀ for straight chains, and C₃-C₃₀ for branched chains), preferably 20 or fewer, more preferably 15 or fewer, most preferably 10 or fewer. Likewise, preferred cycloalkanes have 3-10 carbon atoms in their ring structure, and more preferably have 5, 6, or 7 carbons in the ring structure. The term “hydrocarbon” (or “lower hydrocarbon”) as used throughout the specification, examples, and claims is intended to include both “unsubstituted alkanes” and “substituted alkanes”, the latter of which refers to alkanes having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

The term “lower hydrocarbon”, as used herein, refers generally to a hydrocarbon having a lower overall number of carbon atoms or a lower overall molecular weight as compared to a reference hydrocarbon. Unless the number of carbons is otherwise specified, “lower hydrocarbon” as used herein includes “lower alkanes”, “lower alkenes”, and “lower alkynes” having from one to ten carbons, from one to six carbon atoms, or from one to four carbon atoms in its backbone structure. The lower hydrocarbon can include ethane, ethene, propane, and propene, optionally including one or more substituents or heteroatoms, as well as derivatives thereof.

Suitable heteroatoms can include, but are not limited to, O, N, Si, P, Se, B, and S, wherein the phosphorous and sulfur atoms are optionally oxidized, and the nitrogen heteroatom is optionally quaternized. Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14, 1-12, or 1-6 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, aminoacid, peptide, and polypeptide groups.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen may have hydrogen substituents and/or any permissible substituents of organic compounds described herein which satisfy the valencies of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

The terms “syngas” and “synthesis gas”, as used interchangeably herein, refer to a gas mixture containing mostly hydrogen (H₂) gas and carbon monoxide (CO) gas and about 20 mol-%, 15 mol-%, 12 mol-%, 10 mol-%, 8 mol-%, 6 mol-%, 5 mol-%, or less of other components such as molecular oxygen (O₂), carbon dioxide (CO₂) gas and gases of lower hydrocarbons. The syngas can have about 5 mol-%, 3 mol-%, 2 mol-%, 1 mol-%, or 0.5 mol-% of molecular oxygen. The syngas can have about 15 mol-%, 10 mol-%, 8 mol-%, 6 mol-%, 5 mol-%, 4 mol-%, 3 mol-%, 2 mol-%, or less of carbon dioxide.

The term “high melting point”, when referring to a metal or metal alloy herein, means a metal or metal alloy having a melting point that is about 800° C., 900° C., 1000° C., 1200° C., 1500° C., 2000° C., 2500° C. or higher.

### DESCRIPTION

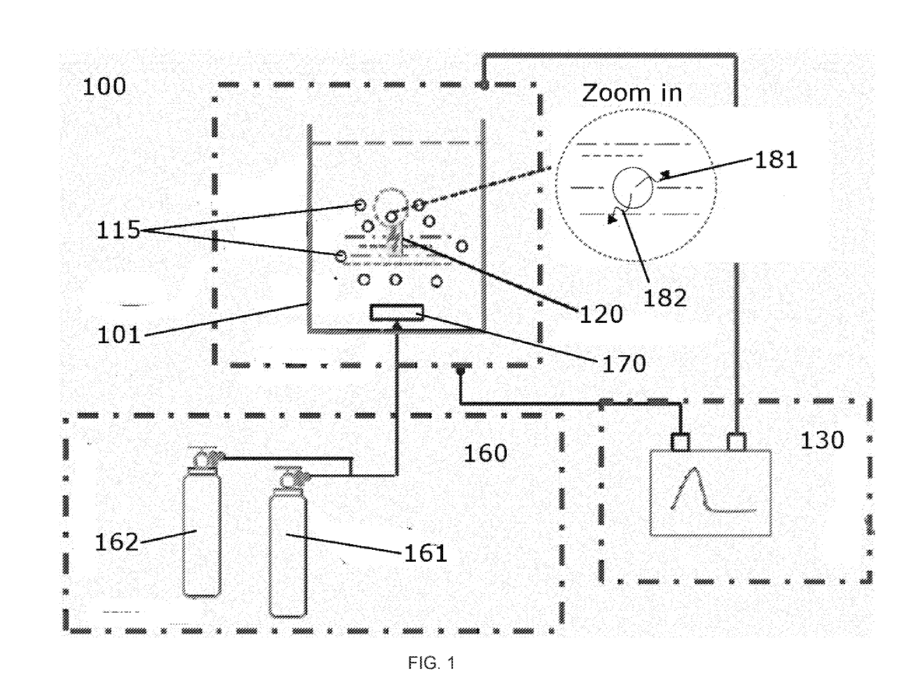

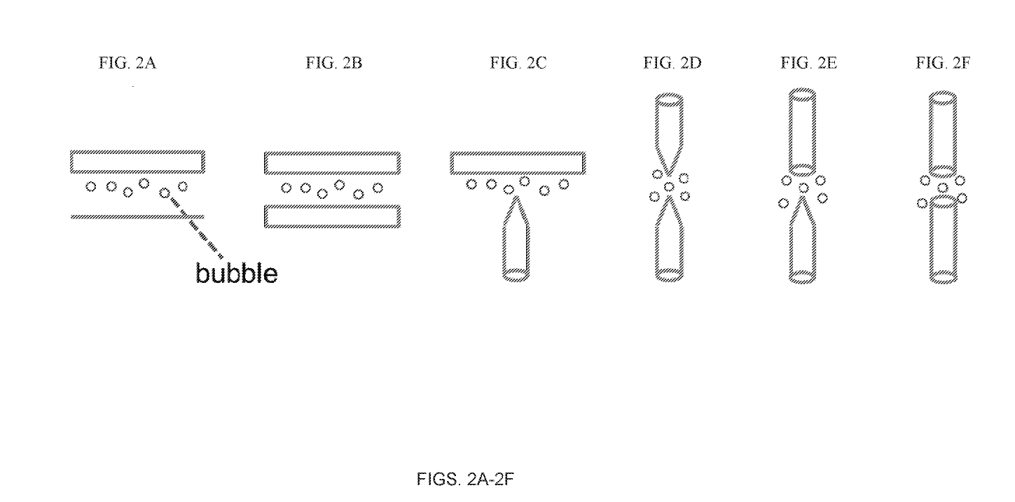

The present disclosure is directed to methods of reformation of gaseous hydrocarbons. An exemplary device 100 and method are depicted in FIG. 1 where a gas source 160 including a gaseous hydrocarbon source 161 and an additive gas 162 are mixed and flow into a gas bubble generator 170 where bubbles 115 are generated containing the gaseous hydrocarbon and the additive gas. The bubbles are generated in a container 101 containing a liquid 110 in such a way that the bubbles pass in a gap between a pair of electrodes (not shown) submerged in the liquid. Exemplary electrodes are shown in FIGS. 2A-2F. An electrical discharge 120 is produced in the electrodes using a power source 130, the electrical discharge causing the reformation of the gaseous hydrocarbon. The liquid provides many benefits including the sorption of water resolvable chemicals 181, the prevention of hydrogen radical termination, and/or rapid cooling of the high temperatures produced by the electrical discharge through rapid heat release 182.

The gaseous hydrocarbons can include any gaseous hydrocarbon source that is a gas at the operable temperature where the method is performed. Preferably, the gaseous hydrocarbon is or contains a hydrocarbon that is a gas at about room temperature, e.g. is a gas at about 20° C., about 21° C., 22° C., 23° C., or less. The gaseous hydrocarbon can include a hydrocarbon having from 1 to 8, 1 to 7, 1 to 6, or 1 to 5 carbon atoms. The gaseous hydrocarbon can include methane, ethane, propane, butane, ethene, propene, butene, ethyne, propyne, butyne, or a mixture thereof. The gaseous hydrocarbon can be essentially pure, i.e. contains essentially just a single type of hydrocarbon and about 5 mol-%, 3 mol-%, 2 mol-%, 1 mol-%, or less of other molecules.

The reformation of the gaseous hydrocarbon can produce a lower hydrocarbon, H₂, CO, H₂O, CO₂, or a mixture thereof. The lower hydrocarbon produced can include ethane, ethylene, propane, propylene, and mixtures thereof. The reformation of the gaseous hydrocarbon can produce a syngas. The reformation of the gaseous hydrocarbon can produce about 15 mol-%, 12 mol-%, 10 mol-%, 8 mol-%, 6 mol-%, 5 mol-%, 4 mol-%, 3 mol-%, 2 mol-%, 1 mol-%, or less of CO₂ and H₂O. The reformation of the gaseous hydrocarbon can produce about 5 mol-%, 10 mol-%, 15 mol-%, 20 mol-%, 25 mol-%, or more of the lower hydrocarbon. The reformation of the gaseous hydrocarbon can produce about 30 mol-%, 40 mol-%, 50 mol-%, 60% mol-%, 70 mol-%, 80 mol-%, or more of H₂.

The methods of reformation of the gaseous hydrocarbon can include generating a bubble in a liquid, the bubble containing the gaseous hydrocarbon. A variety of methods and devices are available for generating bubbles. The bubble can be generated using a bubble generator coupled to a gas source or to a variety of gas sources for the addition of additive gases. In some embodiments the bubble generator is built into one or both of the electrodes. For example, one or both of the electrodes can be a porous electrode or can otherwise have one or more openings coupled to the gas source. The bubbles can be generated from such an electrode. The bubbles can have any size, but will generally be about 0.01 mm to 100 mm, 0.1 mm to 100 mm, 0.1 mm to 50 mm, or 0.1 mm to 20 mm in diameter.

The liquid can typically be any liquid that will support the bubble formation. The liquid can have an electrical conductivity from about 01 μS/cm to about 1000000 μS/cm, e.g. about 0.1 μS/cm to 500000 μS/cm, about 0.5 μS/cm to 500000 μS/cm, about 1 μS/cm to 500000 μS/cm, about 1 μS/cm to 100000 μS/cm, about 1 μS/cm to 50000 μS/cm, about 10 μS/cm to 50000 μS/cm, or about 10 μS/cm to 1000 μS/cm. The methods can also be performed with liquids of varying pH ranging from 0 to 14, e.g. about 1 to 13, 2 to 12, 2 to 11, 3 to 11, 4 to 11, 4 to 10, 5 to 9, or 5.5 to 8.5. The liquid can be water or can be an aqueous based medium. An aqueous based medium can include liquids that are mostly water, e.g. about 51%, 75%, 80%, 90%, or more water.

The bubble containing the gaseous hydrocarbon can also be generated containing one or more additive gases. The additive gases and their percentage of the total gas in the bubble can be varied to impact the production of desired products and/or the efficiency of the reformation process. For example, the amount of additive gas can be varied to control the overall C/O ratio in the mixture of gases in the bubble. Typical additive gases can include, for example, molecular oxygen (O₂), carbon dioxide (CO₂), helium, argon, nitrogen, and mixtures thereof. The additive gases can be added in an amount from about 0.0 mol % to 100 mol %, 0.01 mol % to 99.9 mol %, 1 mol % to 90 mol %, or 10 mol % to 90 mol % based upon the gasses forming the bubble.

Control of the carbon to oxygen ratio (C/O) can affect various aspects of the reformation process including yields of hydrogen and carbon monoxide gases and lower hydrocarbon formation. The C/O ratio can be maintained generally above 0.5. Preferably, the C/O ratio is from 0.5 to 1 and more preferably from 0.6 to 0.95. A C/O ratio of less than 0.5 favors excessive oxidation to yield carbon dioxide and water at the expense of hydrogen and carbon monoxide gases. A C/O ratio above 1 tends to yield incomplete conversion and graphitic coke formation as well as side reactions. In some embodiments the C/O ratio is about 0.1 to 10, 0.1 to 5, 0.5 to 5, 0.5 to 2, or 1 to 2.

The bubble can be generated such that it passes through the liquid and in a gap between a pair of electrodes. The gap between the electrodes can generally be any size small enough such that the electrical discharge or plasma can be generated in the bubble at the gap between the electrodes. The gap between the electrodes can be about 0.1 mm to 1000 mm, 0.1 mm to 500 mm. 1 mm to 500 mm, 1 mm to 100 mm, or 10 mm to 100 mm. The electrodes can be made from a variety of materials capable of withstanding the high voltages, e.g., that have a high melting point to withstand the high temperatures that can be generated. The electrode can contain iron, copper, tungsten, gold, platinum, or alloys or combinations thereof.

The electrodes can have a variety of configurations designed to generate the high electrical discharge in the bubble at the gap. The electrodes can have a wire-like configuration, a plate-like configuration, a pin-like configuration, a rod-like configuration, a cylinder-like configuration, or a combination thereof. The pair of electrodes can be arranged in a wire to plate configuration, a plate to plate configuration, a pin to plate configuration, a pin to pin configuration, a pin to rod configuration, a rod to rod configuration, a wire to cylinder configuration, or a combination thereof. Examples of various electrode configurations for producing electrical discharges are depicted in FIGS. 2A-2F.

The methods can include producing an electrical discharge (e.g. a plasma discharge) in the bubble at the gap between the pair of electrodes, wherein the electrical discharge causes the reformation of the gaseous hydrocarbon. The electrical discharge can be produced from a pulsed power source, an alternating current (AC) power source, or a direct current (DC) power source. The power source can supply large voltages to the electrodes, e.g. up to about 300 kilovolts. The voltage can be up to 200 kilovolts, 1 kilovolt to 200 kilovolts, 10 kilovolts to 200 kilovolts, 20 kilovolts to 200 kilovolts, about 20 kilovolts to 180 kilovolts, about 20 kilovolts to 160 kilovolts, or about 20 kilovolts to 140 kilovolts.

The methods can include controlling the temperature of the liquid to prevent or control the amount of heating caused by the electrical discharge. In some embodiments the temperature of the liquid can be about 100 K to 400 K, 150 K to 400 K, 200 K to 400 K, 200 K to 350 K, or 250 K to 350 K. The temperature of the liquid can be controlled using an air bath, an ice bath, or a liquid bath. The use of the liquid, optionally including controlling the temperature of the liquid, can provide rapid cooling of the liquid and/or the bubble after the electrical discharge. The cooling can be, for example, at about 10⁸ K/s to 10¹⁰ K/s.

This disclosure describes a method for reformation of gaseous hydrocarbons using electrical discharge in an aqueous medium (FIG. 1 shows a typical example of application). By using the present method, multi-function such as rapid cooling of reaction temperature, controlling radical quenching reactions, and products separation, can be realized simultaneously. This method can be used for improving the efficiency of hydrogen production and value-added chemicals such as acetylene production.

For example, a gas mixture containing natural gas and additive gas (e.g. oxygen and carbon dioxide) can be injected into the aqueous reactor so that gas bubbles are produced in the aqueous medium. When electrical discharge is ignited in the gas bubbles, hydrocarbon radicals, such as CH₃, CH₂ and CH radicals are produced from natural gas, O atoms are produced from additive gas, and OH radicals are produced from water. Chemical reactions between hydrocarbon radicals, O atoms and OH radicals lead to the production of value-added chemicals such as heavier hydrocarbons (e.g. ethane and ethylene), and syngas, H₂ and CO, and complete oxidation products, H₂O and CO₂.

The electrical discharge can usually be accompanied by a heat release. Although this heat release can result in a more efficient production of hydrocarbon radicals, O atoms and OH radicals, it can also limit the production of heavier hydrocarbons and syngas due the production of complete oxidation products, CO₂ and H₂O. In this point, the use of aqueous electrical discharge has two major advantages:

(1) The evaporation of water can quickly take away the heat produced from plasma, resulting in a very rapid cooling of reaction temperature (˜10⁹-10¹⁰ K/s), and which can also lead to a high selectivity of heavier hydrocarbons.

(2) The existence of water can facilitate H₂ production because H radical can be produced from the water decomposition, and increased initial concentration of H₂O can minimize radical quenching reaction like H+OH→H₂O.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method of reformation of a gaseous hydrocarbon, the method comprising the steps of:
generating a bubble in a liquid, wherein the bubble comprises the gaseous hydrocarbon and the bubble is generated such that it passes through the liquid and in a gap between a pair of electrodes;
producing an electrical discharge in the bubble at the gap between the pair of electrodes, wherein the electrical discharge causes the reformation of the gaseous hydrocarbon.

2. The method of claim 1, wherein the liquid has an electrical conductivity of about 0.1-1000000 μS/cm.

3-4. (canceled)

5. The method of claim 1, wherein the bubble further comprises an additive gas.

6. The method of claim 5, wherein the additive gas is selected from the group consisting of molecular oxygen (O₂), carbon dioxide (CO₂), and mixtures thereof.

7. The method of claim 1, wherein the bubble is generated using a bubble generator coupled to a gas source.

8. The method of claim 1, wherein at least one electrode in the pair of electrodes comprises one or more openings coupled to a gas source and the bubble is generated using the electrode.

9-14. (canceled)

15. The method of claim 1, wherein the step of producing an electrical discharge is performed with a power supply that supplies up to about 200 kilovolts of voltage to the electrodes.

16. The method of claim 1, wherein the reformation of the gaseous hydrocarbon produces a lower hydrocarbon, H₂, CO, H₂O, CO₂, or a combination thereof.

17. The method of claim 16, wherein the lower hydrocarbon is selected from the group consisting of ethane, ethylene, propane, propylene, and mixtures thereof.

18. The method of claim 1, wherein the reformation of the gaseous hydrocarbon produces a syngas.

19. The method of claim 1, wherein the method further comprises cooling the liquid and/or the bubble at a rate of about 10⁸ K/s to 10¹⁰ K/s.

20. The method of claim 16, wherein the reformation of the gaseous hydrocarbon produces about 15 mol-% or less of CO₂ and H₂O.

21. The method of claim 16, wherein the reformation of the gaseous hydrocarbon produces about 20 mol-% or more of the lower hydrocarbon.

22. The method of claim 16, wherein the reformation of the gaseous hydrocarbon produces about 60% mol-% or more of H₂.

23. A reactor for reformation of a gaseous hydrocarbon comprising:
a container for holding a liquid;
a gas source including a gaseous hydrocarbon source fluidly communicating with the container and including gaseous hydrocarbon;
a pair of electrodes located in the liquid of the container; and
a power source electrically connected to the pair of electrodes,
wherein a bubble is generated in the liquid to passes through a gap between the pair of electrodes,
wherein the bubble includes the gaseous hydrocarbon, and
wherein the power source generates an electrical discharge in the bubble at the gap between the pair of electrodes and the electrical discharge causes the reformation of the gaseous hydrocarbon.

24. The reactor of claim 23, wherein the gas source further comprises:
an additive gas source holding an additive source,
wherein the gas source is configured to mix the gaseous hydrocarbon with the additive gas.

25. The reactor of claim 23, further comprising:
a bubble generator located inside the container and in fluid communication with the gas source, the bubble generator being configured to generate the bubble.
